(19) United States
(12) Patent Application Publication
(10) Pub. No.: US 2009/0181278 A1
(43) Pub. Date: Jul. 16, 2009

(54) MICRO FUEL CELL, FABRICATION METHOD THEREOF, AND MICRO FUEL CELL STACK USING THE SAME

(75) Inventors: Ji-Won Son, Seoul (KR); Hae-Weon Lee, Seoul (KR); Ki-Bum Kim, Seoul (KR); Chang-Woo Kwon, Gyeonggi-Do (KR); Jong-Ho Lee, Seoul (KR); Hae-Ryoung Kim, Seoul (KR)

Correspondence Address: Vierra Magen Marcus & DeNiro LLP, 575 Market Street, Suite 2500, San Francisco, CA, 94105, US

(73) Assignee: KOREA INSTITUTE OF SCIENCE AND TECHNOLOGY, Seoul (KR)

(21) Appl. No.: 12/261,962

(22) Filed: Oct. 30, 2008

(30) Foreign Application Priority Data
Jan. 15, 2008 (KR) 10-2008-0004597

(51) Int. Cl. H01M 8/10; C23F 1/00

(52) U.S. Cl. 429/30; 216/17

(57) ABSTRACT

A micro cell fuel cell using a nano porous structure according to a thin film process and an anodizing process as a template for implementing a porous structure of an electrode, its fabrication method, and a micro fuel cell stack using the same are disclosed. The micro-fuel cell includes a solid electrolyte and first and second electrodes separately formed on the electrolyte, wherein at least one of the first and second electrodes is supported by a template having a plurality of nano pores formed by depositing, anodizing and etching a thin film, and is a porous electrode with nano pores formed at positions corresponding to the entirety or a portion of the plurality of nano pores formed on the template. The micro-fuel cell can be fabricated based on the thin film process, and unit cells can be highly integrated to implement a micro-fuel cell system generating a high voltage and a high current.

### RELATED APPLICATION

This application claims priority from Korean Patent Application No. 10-2008-0004597, filed on Jan. 15, 2008, which is herein expressly incorporated by reference in its entirety.

### BACKGROUND OF THE INVENTION

1. Field of the Invention

The present invention relates to a micro fuel cell using a nano porous structure according to a thin film process and an anodizing process as a template for implementing a porous structure of an electrode, its fabrication method, and a micro fuel cell stack using the same.

2. Description of the Related Art

Recently, as the function of mobile electronic devices are being diversified and complicated, power of existing mobile terminals cannot meet an increasingly requested amount of an energy density, and thus, development of a new mobile power source is increasingly on demand. Conditions for a new small power source include high power and energy densities, a long operation time and life span, a low cost, and so on, and a fuel cell has been considered as an alternate that meets such conditions.

A fuel cell basically includes an electrolyte, a cathode and an anode. Types of fuel cells are commonly divided by their electrolyte materials, and among them, a fuel cell using a solid oxide, namely, a ceramic material, as an electrolyte is called a solid oxide fuel cell (SOFC). The SOFC has a high efficiency compared with other fuel cells and has been developed for large-scale power generation applications. Recently, as the demands for mobile power with high power and high energy densities are increasing, development of the SOFC as a micro-portable power source draws much attention.

In order to develop the existing large-scale SOFC as a micro-portable power source, a low temperature operation and size reduction should be necessarily accomplished. The existing large-scale SOFC has an operation temperature of about 800° C. or higher, which is so quite high as to cause an interface reaction and a thermal expansion mismatch of components such as electrolyte, electrodes, a sealing material, and the like, resulting in degradation of performance of the SOFC. In particular, in a small power source application, lowering of the operation temperature is very critical for facilitating thermal management. But lowering of the operation temperature would cause lowering of conductivity of electrolyte or activity of catalyst to reduce performance, so a new material should be employed or the structure should be changed to complement them.

In particular, compensating a reduction in conductivity of electrolyte caused by the lower operation temperature is mitigated by reducing the thickness of electrolyte to thus reduce resistance is one of the major research fields, for which introduction of a thin film process instead of a conventional bulk ceramic process is being studied. In addition, in reducing the size of the fuel cell, when a fuel cell element with a size ranging from the existing centimeter (cm), meter (m), a millimeter (mm) and to a micrometer is fabricated, the existing bulk process has a limitation, so miniaturization technique such as thin film processes, micro-fabrication, MEMS (Micro Electro-Mechanical Systems) or the like are important for the small SOFC. Thus, a nano-micro technology for maintaining a high power and energy density at a low operating temperature (e.g., improvement of low temperature performance by making thin film electrolytes and nano-structured electrodes, etc.), and the micro-fabrication technology and MEMS technology for integration and miniaturization of a fuel cell in consideration of compatibility of elements of the fuel cell made to be thin film and nano-structures, are requisite for implementing a micro-SOFC.

However, the existing semiconductor device process performed at a room temperature or slightly higher cannot guarantee a thermal and mechanical stability of the elements over the operation conditions of the SOFC as high as hundreds of degrees centigrade, and in particular, the thin film process in which the two-dimensional dense structure is dominant has a limitation in fabricating an electrode of a porous structure requiring an effective low temperature operation. Thus, in order to implement micro-SOFC, development and application of a process that can implement a complicated structure having high temperature stability as well as being compatible with the thin film process, the MEMS, and the like, are required.

The existing methods implementing the porous electrode structure by using the thin film process include a method in which an electrode material is less densely deposited by using a high processing pressure or the like and induced to be coagulated by thermal energy through a follow-up thermal treatment to obtain pores (Huang et al, J. Electrochemical Soc., 154(1) B20-24), a method in which a processing pressure and a deposition temperature are increased to deposit a porous thin film (A. F. Jankowski et al., J. Vac. Sci. Tech., A 21(2), 422-425), a method in which an electrode material is simultaneously deposited together with a sacrificial material that can be remove in a follow-up process or deposited by using a reaction gas, and then only a porous electrode remains by performing a following process such as reducing process or an acid treatment (L. Maya et al, J. Appl. Electrochemistry, 29, 883-888), and the like.

However, these methods may be performed, without causing a problem, to implement the porous electrodes and operate them at a relatively low temperature or short term operation at a high temperature, but they are not suitable for the operation conditions of the SOFC. That is, the SOFC is performed at a high temperature, during which an actual temperature goes up higher than a set temperature due to an electrochemical reaction, promoting metal to coalesce due to thermal energy to lose interconnectivity or degrade adhesiveness between metal agglomerate and the electrolyte.

### SUMMARY OF THE INVENTION

Therefore, in order to address the above matters, the various features described herein have been conceived. One aspect of the exemplary embodiments is to provide a micro-fuel cell capable of maintaining structural stability at a high temperature and having an enhanced reliability and long-term life span stability by restraining coagulation of electrode material due to thermal energy at a high temperature.

Another aspect of the present invention is to allow a fabrication technique of an electrode structure having a high temperature structure stability to be compatible with a thin film process, a micro-fabrication technique, an MEMS technique, or the like to enable diverse fuel cell designs, pattern implementation and integration, reduce the size of a fuel cell, and reduce the integration and production costs.

This specification provides a micro-fuel cell including a solid electrolyte and first and second electrodes separately formed on the electrolyte, wherein at least one of the first and second electrodes is supported by a template having a plurality of nano pores formed by depositing, anodizing and etching a thin film, and is a porous electrode with nano pores formed at positions corresponding to the entirety or a portion of the plurality of nano pores formed on the template.

This specification also provides a micro-fuel cell stack wherein a plurality of unit cells are disposed on a substrate, arbitrary two unit cells among the plurality of unit cells are connected in series or in parallel via a connection line, the unit cells include a solid electrolyte and the first and second electrodes separately formed on the electrolyte, wherein at least one of the first and second electrodes is supported by a template having a plurality of nano pores formed by depositing, anodizing and etching a thin film, and is a porous electrode with nano pores formed at positions corresponding to the entirety or a portion of the plurality of nano pores formed on the template.

This specification also provides a method for fabricating a micro-fuel cell, including: depositing a raw material of a template on a substrate through a thin film process; anodizing the deposited thin film to form an anodized thin film (anodized aluminum oxide layer) having a porous layer and a barrier layer; forming a first electrode with a uniform thickness on the anodized thin film; forming an electrolyte on the first electrode; forming a second electrode on the electrolyte; and etching the barrier layer and portions of the first electrode formed on the barrier layer to form a plurality of nano pores at the first electrode.

This specification also provides a method for fabricating a micro-fuel cell, including: depositing a raw material of a template on a substrate through a thin film process; forming a first electrode on the deposited template thin film; forming an electrolyte on the first electrode; forming a second electrode on the electrolyte; forming an opening from a lower surface of the substrate up to a lower surface of the template thin film on the substrate; anodizing the template thin film to form an anodized thin film having a porous layer and a barrier layer; and etching the barrier layer and portions of the first electrode being in contact with the barrier layer to form a plurality of nano pores at the first electrode.

This specification also provides a method for fabricating a micro-fuel cell, including: forming an opening on a lower surface of a substrate; depositing a raw material of a template on the portion of the substrate where the opening is formed through a thin film process; anodizing the template thin film to form an anodized thin film having a porous layer and a barrier layer; forming a first electrode with a uniform thickness on the anodized thin film; etching an upper surface of the substrate, the barrier layer, and portions of the first electrode formed on the barrier layer to form a plurality of nano pores at the first electrode; forming an electrolyte on the porous layer; and forming a second electrode on the electrolyte.

According to the present invention, by implementing a porous structure of an electrode by using a nano-porous structure formed through a thin film process and anodizing as a template of the electrode, good structural stability at a high temperature can be obtained owing to the support effect of the template, and the drawbacks of the existing single-phase porous thin film electrode in terms of performance and long-term stability can be removed.

In particular, because the technique is implemented by using the thin film process that allows integration and mass production, its implantability, expandability and generality (universality or compatibility) to a different technique can be improved.

In addition, according to the present invention, a unit cell of the fuel cell can be highly integrated and become very small in size as a next-generation portable small power supply device, so the micro-fuel cell has a high economical value.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1C are perspective, sectional and plan views of a micro-fuel cell according to a first embodiment of the present invention;

FIG. 2 is a sectional view of a micro-fuel cell according to a second embodiment of the present invention;

FIG. 3 is a sectional view of a micro-fuel cell according to a third embodiment of the present invention;

FIG. 4 is a sectional view of a micro-fuel cell according to a fourth embodiment of the present invention;

FIG. 5 is a sectional view of a micro-fuel cell according to a fifth embodiment of the present invention;

FIG. 6 is a sectional view of a micro-fuel cell according to a sixth embodiment of the present invention;

FIG. 7 is a sectional view of a micro-fuel cell according to a seventh embodiment of the present invention;

FIGS. 8A to 8J show sequential process of a method for fabricating a micro-fuel cell according to a first embodiment of the present invention;

FIGS. 9A to 9I show sequential process of a method for fabricating a micro-fuel cell according to fourth and fifth embodiment of the present invention;

FIGS. 10A to 10I show sequential process of a method for fabricating a micro-fuel cell according to a seventh embodiment of the present invention;

FIG. 11 is a sectional view of a micro-fuel cell stack of a serial connection structure according to one embodiment of the present invention;

FIG. 12 is a sectional view of a micro-fuel cell stack of a serial connection structure according to another embodiment of the present invention;

FIG. 13 is a conceptual view of a packaging system constituting a gas flow path in a micro-fuel cell in FIG. 11;

FIG. 14 is a conceptual view of a packaging system constituting a gas flow path in a micro-fuel cell in FIG. 12; and

FIG. 15 shows photo images of an SEM of a micro-fuel cell fabricated according to a first embodiment of the present invention.

### DETAILED DESCRIPTION OF THE INVENTION

Exemplary embodiments of the present invention will now be described in detail with reference to the accompanying drawings.

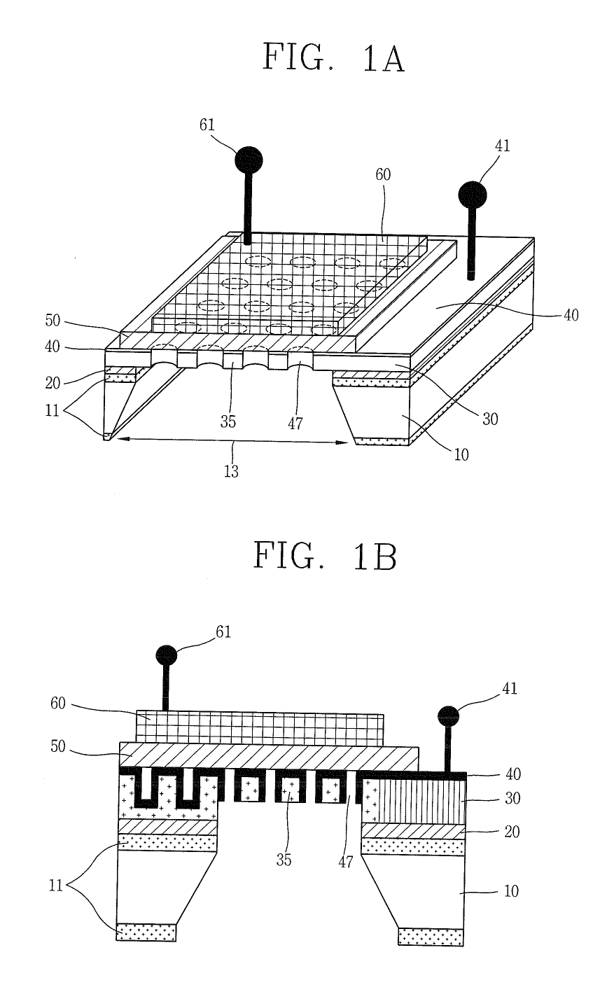

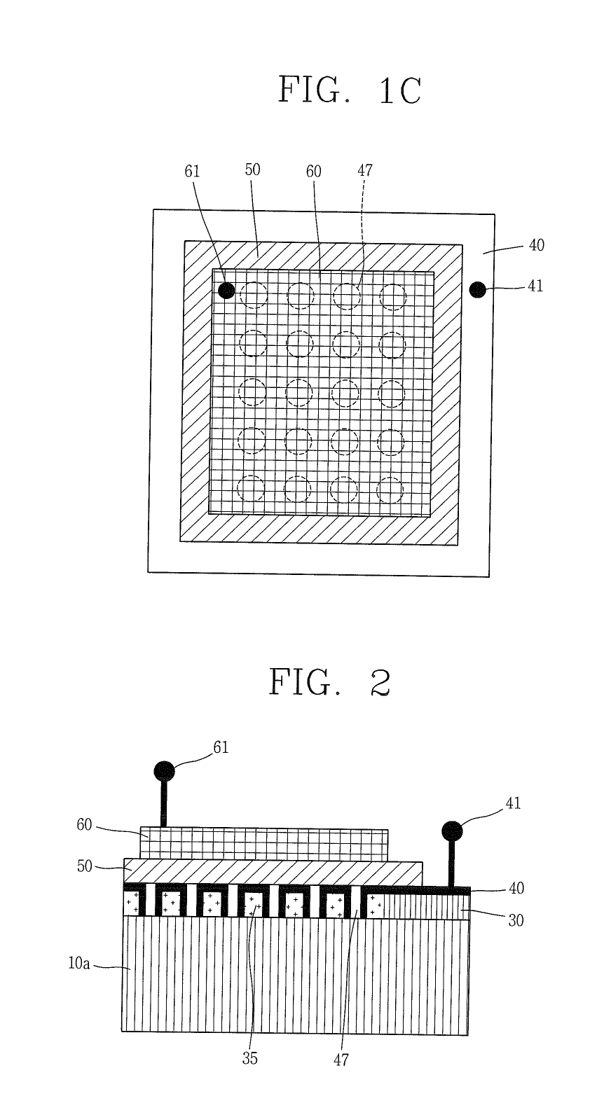

As shown in FIGS. 1A to 1C, a micro-fuel cell according to a first embodiment of the present invention includes a solid electrolyte 50 and first and second electrodes 40 and 60 separately formed on the electrolyte 50.

The micro-fuel cell according to the present invention may have such a structure that the electrolyte 50 is positioned between the first and second electrodes 40 an 60 as shown in FIG. 1B, or although not shown, the micro-fuel cell may have a structure that the first and second electrodes 40 and 60 may be disposed together on one surface of the electrolyte 50 (See Korean Patent Registration No. 10-7024120).

The first electrode 40 is an anode and may be made of a material selected from the group consisting of a metal such as nickel (Ni), ruthenium (Ru), palladium (Pd), rhodium (Rd), platinum (Pt), or their alloy, a cermet complex of the metal and YSZ, GDC, etc., a ruthenium oxide, and the like.

The second electrode 60 is a cathode and made of a material selected from the group consisting of platinum (Pt), gold (Au), lanthanum oxide-based perovskite such as lanthanum-strontium iron (LSF) oxide, lanthanum-strontium cobalt iron (LSCF) oxide, samarium-strontium cobalt (SSC) oxide, bismuth-ruthenium oxide-based electrode, and the like.

In a different embodiment, the first electrode 40 may be a cathode, while the second electrode 60 may be an anode.

The electrolyte may be selected from the group consisting of zirconium oxide (ZrxOy), cerium oxide (CexOy), lanthanum gallate, barium cerate, barium zirconate, bismuth-based oxide, oxygen ion conducting materials such as several doping phases of the materials, or ion conducting materials such as a proton conducting materials.

In the present invention, at least one of the first and second electrodes 40 and 50 is supported by a template 35 having a plurality of nano pores formed by depositing, anodizing and then etching a thin film, and is a porous electrode having nano pores 47 at positions corresponding to the entirety or a portion of the plurality of nano pores formed at the template 35.

In the present invention, only the first electrode 40 is formed as the porous electrode, but without being limited thereto, the second electrode 60 may be formed as a porous electrode according to the method of the present invention or both the electrodes 40 and 60 may be formed at porous electrodes.

With reference to FIG. 1B, the corrugated surface (i.e. pore formed surface) of the template 35 formed according to anodizing is directed upwardly and the porous electrode 40 is formed with a uniform thickness on an upper surface of the template 35 and inner walls constituting the nano pores of the template 35. As a raw material of the first electrode 40 is deposited with the uniform thickness on the corrugated surface of the template 35, the first electrode 40 is supported by the template 35, and the nano pores of the first electrode 40 are formed at the same positions as the nano pores formation positions of the template 35 via the follow-up etching process.

The template 35 may be made of any material so long as it can implement the regular pore structure through the anodizing process after the thin film is deposited, and may be made of at least one selected from the group consisting of aluminum (Al), titanium (Ti), magnesium (Mg), Zinc (Zn), tantalum (Ta), zirconium (Zr), Yttrium (Y), cerium (Ce), hafnium (Hf), niobium (Nb), and silicon (Si) or their alloys.

As shown in FIG. 1B, because the porous electrode 40 already secures the pores 47, the passage through which gas is to move, so it may become highly dense as well as porous.

The average diameter of the nano pores formed in the porous electrode may be 10 nm or larger. If the average diameter is smaller than 10 nm, it is difficult for a fuel, air, or steam of moisture, a fuel cell reaction by-product to properly transmit therethrough. An upper limit of the size of the nano pores may be determined in consideration of the number of triple phase boundaries, a mechanical stability of membrane, and the like.

The template is supported by the substrate 10, and the substrate 10 includes an opening in order to secure a gas movement passage up to the nano pores 47 formed at the porous electrode 40.

The substrate 10 may be made of a material selected from the group consisting of electronic conducting materials, electronic non-conducting materials, semi-conducting materials, oxygen ion conducting materials, proton conducting materials, and the like. For example, may be made of a material selecting from the group consisting of silicon (Si), silicon oxide (SiOx), silicon nitride (SixNy), aluminum oxide (AlxOy), magnesium oxide (MgxOy), titanium oxide (TixOy), zirconium oxide (ZrxOy), cerium oxide (CexOy), lanthanum gallate, barium cerate, barium zirconate, bismuth-based oxide, or several doping phases of the materials.

If semi-conducting materials or conducting materials such as silicon wafer are used as the material of the substrate 10, an insulation and thermal expansion mismatch buffer layer may be further formed on the substrate. Here, the thermal expansion mismatch buffer layer refers to a buffer layer for restraining stress due to thermal expansion. For example, the buffer layer may be made of one of materials selected from the group consisting of silicon oxide (SiOx), silicon nitride (SixNy), aluminum oxide (AlxOy), magnesium oxide (MgxOy), titanium oxide (TixOy), zirconium oxide (ZrxOy), cerium oxide (CexOy), lanthanum gallate, barium cerate, barium zirconate, bismuth-based oxide, or several doping phases of the materials.

The substrate 10 may not necessarily serve as the support but the electrolyte may be formed with a proper thickness to serve as a support instead (See FIG. 6).

Also as shown in FIG. 1B, a lower electrode 20 is formed below the template 35. The lower electrode 20 is required for applying power for the anodizing process. Because the template 35 has the form of a thin film, preferably, the regular porous channels may be formed by using the lower electrode 20. If the substrate 10 is a conductor (conducting material), the lower electrode 20 may be omitted.

FIG. 2 shows a micro-fuel cell according to a second embodiment of the present invention. The micro-fuel cell according to the second embodiment of the present invention is almost the same as that of the first embodiment except that a porous substrate having a porous structure overall is used as a substrate 10a.

As shown in FIG. 2, the substrate 10a supports the template 35, and by having the porous structure overall, the substrate 10a secures an air movement passage up to the nano pores 47 formed in the porous electrode 40. By not having such an opening as that in the first embodiment, the substrate 10a is advantageous for guaranteeing a mechanical stability.

The substrate 10a having the overall porous structure may include, for example, an anode-electrolyte complex having pores secured at positions where oxygen is removed as used in the existing SOFC, a porous ceramic insulator, a porous metal support, porous silicon using anodization, an aluminum bulk article, and the like.

If the substrate 10a is not made of a conductor, the lower electrode (not shown in FIG. 2) may be formed between the template 35 and the substrate 10a.

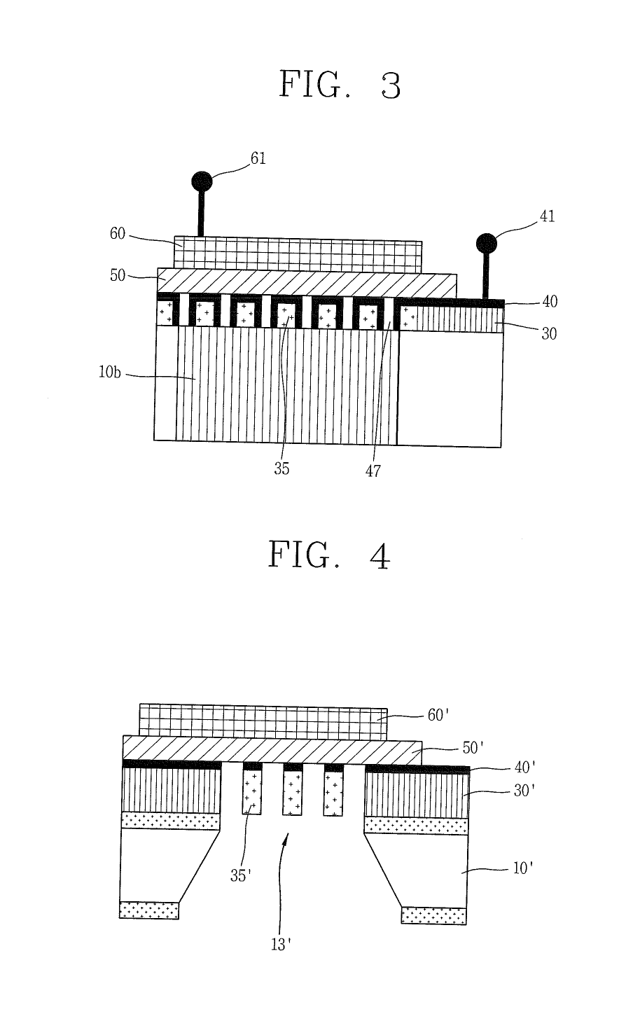

FIG. 3 is a sectional view of a micro-fuel cell according to a third embodiment of the present invention.

The micro-fuel cell according to the third embodiment of the present invention is almost the same as that of the second embodiment of the present invention, except that a porous substrate having a partial porous structure is used as a substrate 10b.

As shown in FIG. 3, the substrate 10b is supported by the template 35, and by having a partial porous structure, the substrate 10a secures a gas phase movement passage up to the nano pores 47 formed in the porous electrode 40. By not having such an opening as that in the first embodiment, the substrate 10a is advantageous for guaranteeing a mechanical stability.

The partial porous structure can be obtained such that the substrate is patterned to form a trench and the trench is then filled with frit. The frit is a porous material obtained by firing (sintering) small spherical particles of a proper material. Also, the partial porous structure may be implemented by silicon or aluminum obtained by patterning and anodizing the substrate. But the present invention is not limited thereto.

FIG. 4 is a sectional view of a micro-fuel cell according to a fourth embodiment of the present invention.

Unlike the micro-fuel cells according to the first to third embodiments of the present invention, in the fourth embodiment of the present invention, an corrugated surface of the template 35′ formed by an anodizing process is directed downward, and a porous electrode 40′ is formed between the template 35′ and an electrolyte 50′. As a raw material of the first electrode 40′ is deposited on a flat surface of the template 35′, the first electrode 40′ is supported by the template 35′. And nano pores of the first electrode 40′ are formed at the same positions as the nano porous formation positions of the template 35′ through a follow-up etching process.

In the fourth embodiment of the present invention, power is applied to the first electrode 40′ in performing the anodizing process, so such a lower electrode as that in the first embodiment is not necessary.

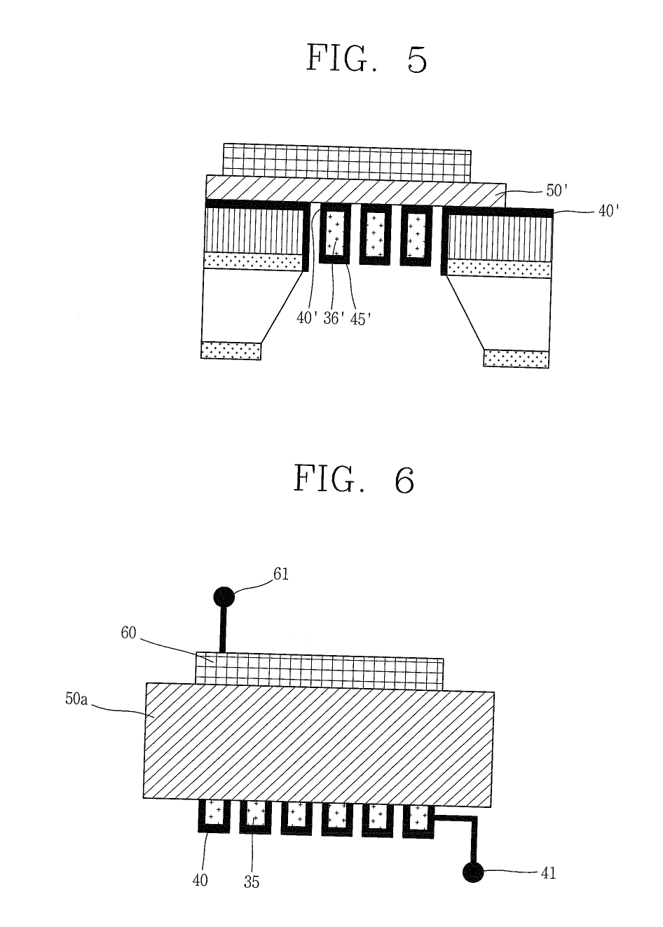

FIG. 5 is a sectional view of a micro-fuel cell according to a fifth embodiment of the present invention. The micro-fuel cell according to the fifth embodiment of the present invention is the same as that in the fourth embodiment of the present invention, except that the same material as or a different material from the electrode material 40′ is additionally deposited on the template 35′. The detailed fabrication process will be described later.

FIG. 6 is a sectional view of a micro-fuel cell according to a sixth embodiment of the present invention. In the sixth embodiment of the present invention, an electrolyte 50a is formed with more than a certain thickness and used, rather than using the substrate as a support. The electrode is implemented as that of the fourth and fifth embodiments.

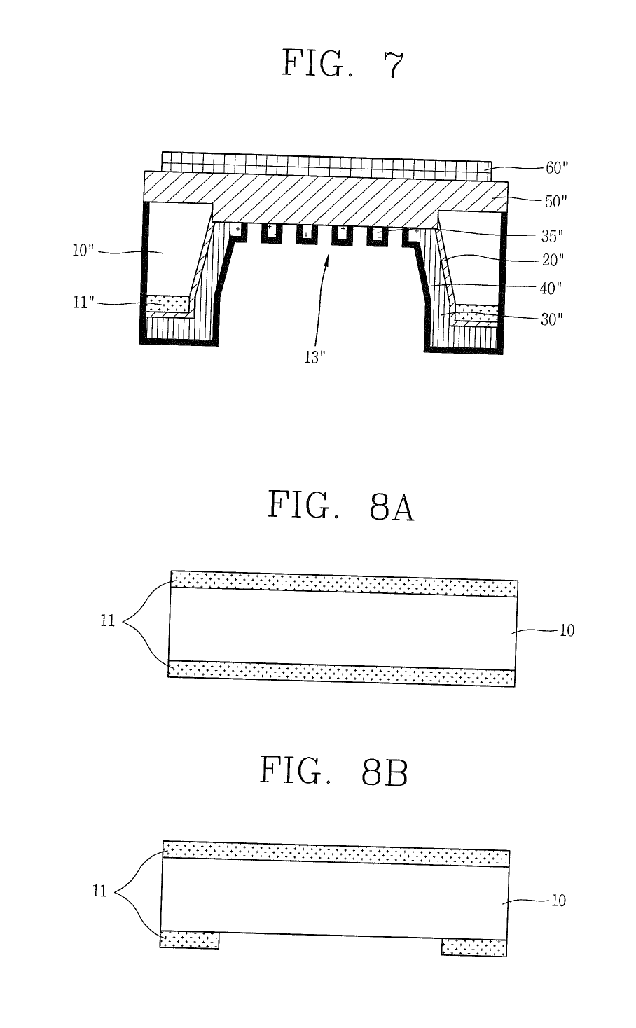

FIG. 7 is a sectional view of a micro-fuel cell according to a seventh embodiment of the present invention.

In the seventh embodiment of the present invention, an corrugated surface of a template 35″ formed by an anodizing process is directed downwardly, the opposite direction to an electrolyte, and the porous electrode is formed with a uniform thickness on a lower surface of the template and on inner walls constituting the nano pores of the template. As a raw material of a first electrode 40″ is deposited with a uniform thickness on the corrugated surface of the template 35″, the first electrode 40″ is supported by the template 35″, and nano pores of the first electrode 40″ are formed at the same positions as the nano pores formation positions of the template 35″ through an etching process.

A method for fabricating a micro-fuel cell according to the present invention will now be described.

A method for fabricating a micro-fuel cell according to an embodiment of the present invention includes: depositing a raw material of a template on a substrate according to a thin film process; anodizing the deposited thin film to form an anodized thin film (anodized aluminum oxide layer) having a porous layer and a barrier layer; forming a first electrode with a uniform thickness on the anodized thin film; forming an electrolyte on the first electrode; forming a second electrode on the electrolyte; etching the barrier layer and portions of the first electrode formed on the barrier layer to form a plurality of nano pores at the first electrode.

Here, the deposition of the raw material of the template and the formation of the first and second electrodes and the electrolyte may be performed by using various thin film deposition methods such as 1) chemical vapor deposition (CVD), 2) physical vapor deposition such as pulse laser deposition (PLD), electron beam deposition or sputtering, 3) a sol-gel method, a spray method, and a spin-on method. But the present invention is not limited thereto.

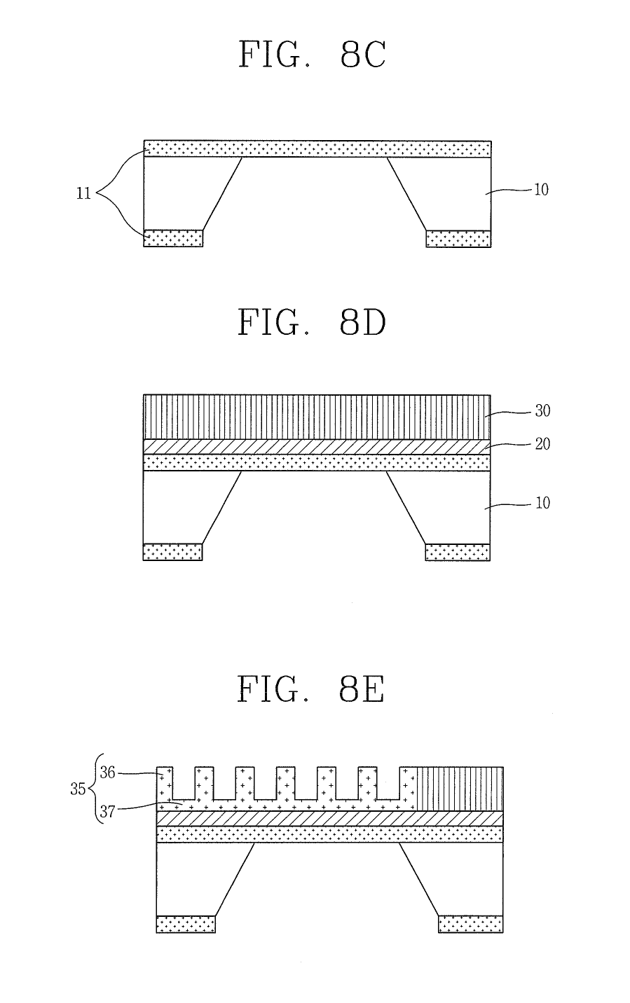

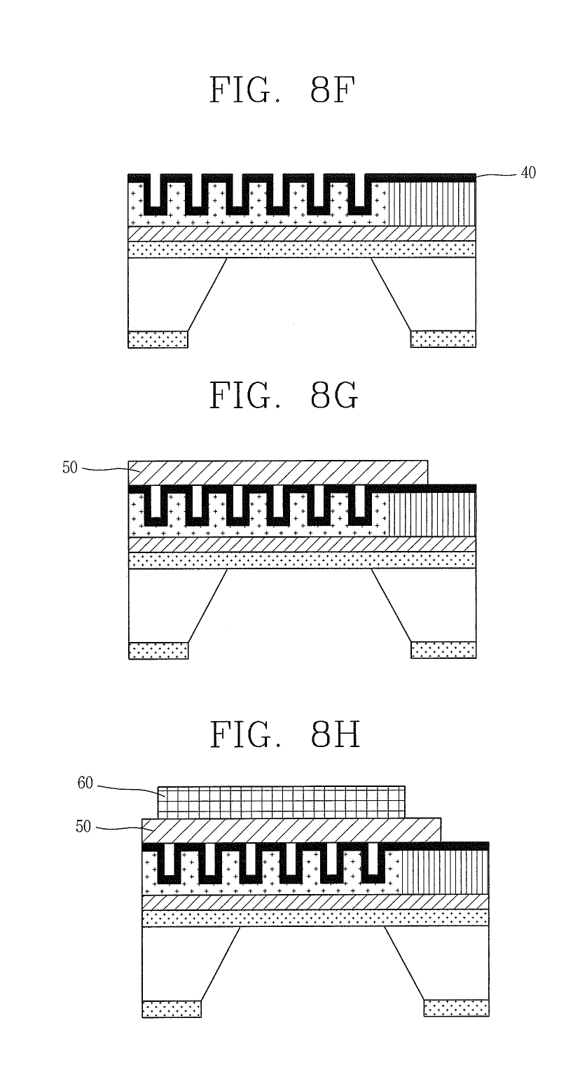

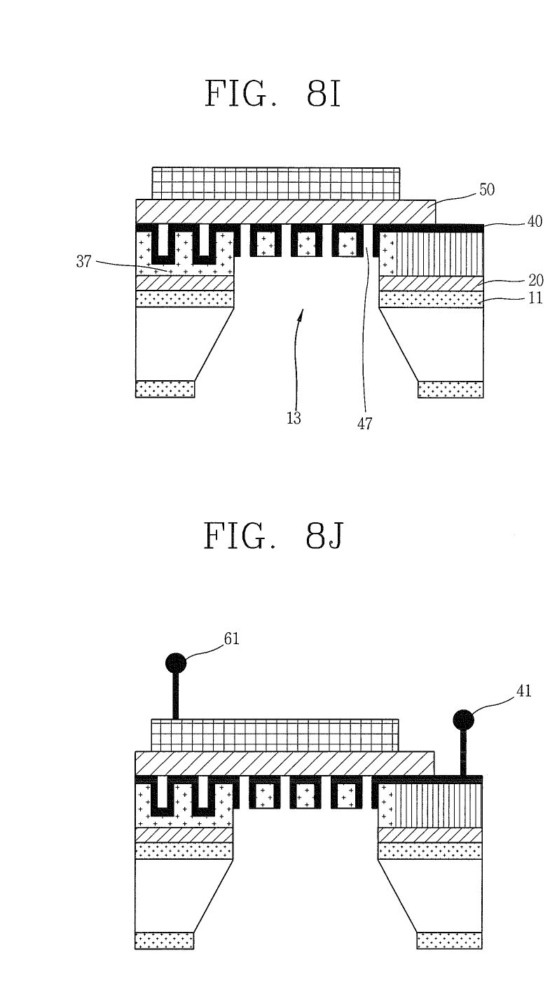

In detail, the method of fabricating the micro-fuel cell according to the first embodiment of the present invention will now be described with reference to FIGS. 8A to 8J.

First, silicon nitride (SixNy)(e.g. Si3N4) layers 11 are formed on both sides of a silicon substrate 10 by using the thin film process such as low pressure chemical vapor deposition (LPCVD) (FIG. 8A). Here, silicon oxide can be used as the layers 11 instead of silicon nitride. The silicon nitride layers serve as masks for patterning an etched portion and as etch stops.

Next, the silicon nitride layer 11 is patterned by using photoresist (FIG. 8B). The patterning includes a photoresist spin-on coating, lithography, photoresist developing, and selectively etching the silicon nitride layer. In this case, a photoresist removing process is performed after finishing the etching process.

And then, an exposed Si portion is removed with KOH or the like by using the patterned silicon nitride layer 11 as an etching mask (FIG. 8C). Alternatively, an exposed Si portion can be dry-etched using RIE (Reactive Ion Etching).

Thereafter, a lower electrode 20, which may serve as an electrode when anodized aluminum oxide (AAO) layer is formed, is deposited on the substrate 10 with the silicon nitride layer formed thereon, on which an Al layer 30 is then formed through sputtering or the like (FIG. 8D). The lower electrode 20 is made of a material with conductivity including Ti, TiN, Ru, or the like. If the substrate 10 is a conductor, the lower electrode 20 may be omitted.

Subsequently, an anodizing process is performed to form an AAO layer 35 having a porous layer 36 and a barrier layer 37 (FIG. 8E).

And then, a first electrode 40 material is deposited with a uniform thickness on the AAO layer 35 by using CVD method such as atomic layer deposition (ALD) or the like, or using PVD method (FIG. 8F). If necessary, the first electrode 40 may be thermally treated after being formed.

An electrolyte 50 is formed on the AAO-first electrode complex structure (FIG. 8G). The electrolyte 50 obtains crystallinity (is crystallized) through a high temperature deposition or through thermal treatment after deposition. In order to form a dense electrolyte by closing the top surface of the pores of the first electrode, the physical deposition method such as the PLD or sputtering are preferred.

And then, a second electrode 60 is formed on the electrolyte 50 (FIG. 8H). If necessary, a follow-up thermal treatment may be performed.

After the first electrode, the electrolyte and the second electrode as shown in FIGS. 8F, 8G and 8H are formed, thermal treatment for improving physical properties or crystallization may be performed sequentially after each step or may be simultaneously performed following two or three steps.

Thereafter, the silicon nitride layer 11, the lower electrode, the barrier layer 37 and portions of the first electrode deposited on the barrier layer are removed through etching to complete an opening 13 (FIG. 8I). Accordingly, pores 47, passages allowing gas (fuel or air) to reach the first electrode 40 and the electrolyte 50 therethrough are formed. Two or more openings 13 may exist per unit cell. In this case, the effective area of the three-phase boundary can be extended while obtaining bearing power by the substrate.

Finally, a first current collector 41 connected with the first electrode and a second current collector 61 connected with the second electrode are formed for current collection (8J).

The fabrication process order in the first embodiment as shown in FIGS. 8A to 8J may be modified. For example, in order to secure structural stability during the processing procedure, the etching process as shown in FIGS. 8B and 8C may be performed between the step as shown in FIG. 8H and the step as shown in FIG. 8I after the second electrode 60 is formed.

If the step of forming the opening 13 is excluded and the substrate is substituted with the porous substrate in the fabrication process according to the first embodiment of the present invention, the structure according to the second and third embodiment as described above can be obtained. In this case, etching of the barrier layer 37 and portions of the first electrode 40 mounted on the barrier layer is performed through pore passages secured in the porous substrate.

The method in which the material to be anodized is deposited according to the thin film process and then anodized and etched to form the nano-pore structure so as to be used as the template is advantageous in that because the patterning is easy, a complicated structure can be simply implemented, it can be easily applied to various modification structures. Namely, the configuration of the electrode part can be implemented by using the anodized porous structure for a type in which the first and second electrodes are disposed together on one surface of the electrolyte as disclosed in Korean Patent Registration No. 10-0724120 by the same inventers as those of the present invention, as well as the type in which the electrolyte is positioned between the first and second electrodes presented in the several embodiments of the present invention, and the electrode dispositions can be modified variably.

The method for fabricating a micro-fuel cell according to another embodiment of the present invention includes: depositing a raw material of a template on a substrate through a thin film process; forming a first electrode on the deposited template thin film; forming an electrolyte on the first electrode; forming a second electrode on the electrolyte; forming an opening from a lower surface of the substrate to a lower surface of the template thin film; anodizing the template thin film to form an anodized aluminum oxide (AAO) layer having a porous layer and a barrier layer; and etching the barrier layer and portions of the first electrode being in contact with the barrier layer to form a plurality of nano pores at the first electrode.

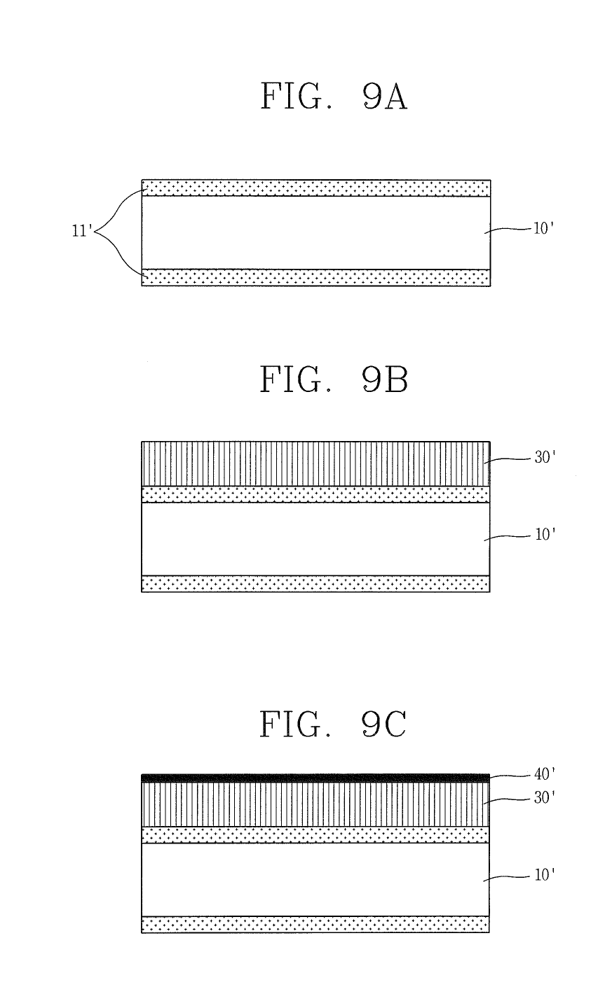

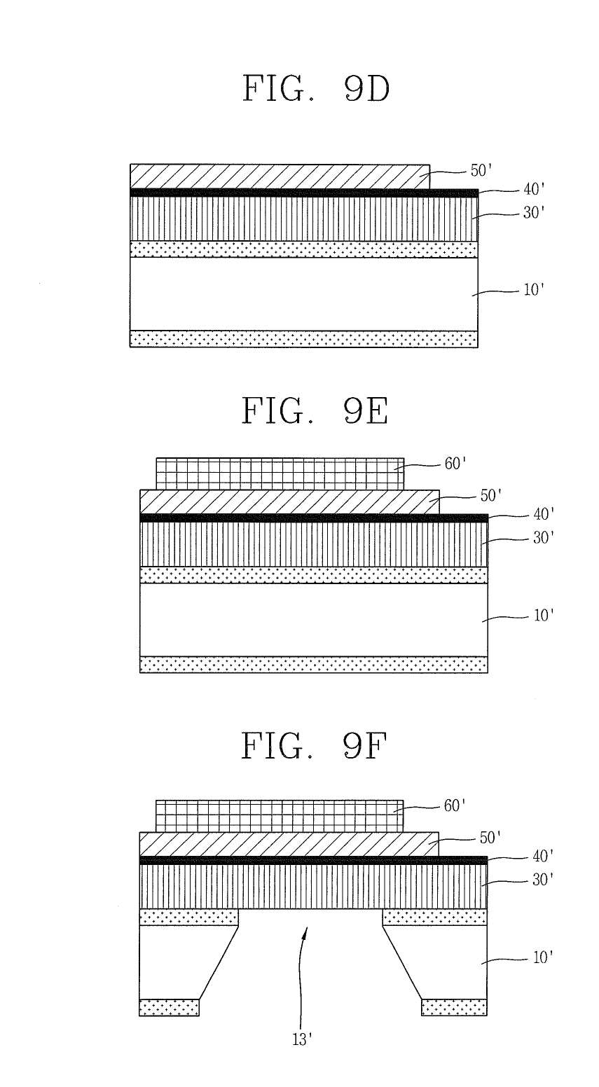

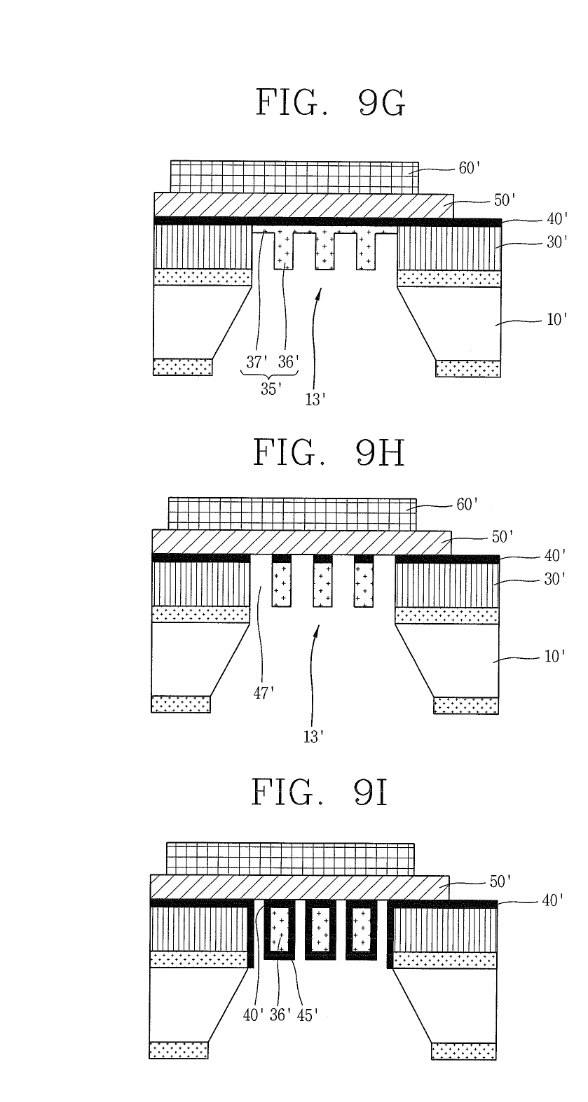

The method for fabricating a micro-fuel cell according to fourth and fifth embodiments of the present invention will now be described with reference to FIGS. 9A to 9I.

First, silicon nitride (or silicon oxide) layers 11′ are formed on both sides of a silicon substrate 10′ by using the thin film process such as low pressure chemical vapor deposition (LPCVD) (FIG. 9A). The silicon nitride layers serve as masks for patterning an etched portion and as etch stops.

Next, an Al layer 30′ is formed on the substrate 10′ with the silicon nitride layer formed thereon through sputtering (FIG. 9B). In this embodiment, an anodizing process is performed upwardly on the drawing, so an electrode is not necessary at a lower portion of the Al layer.

Thereafter, a first electrode 40′ material is deposited on the Al layer through PVD such as sputtering or the like (FIG. 9C). If necessary, thermal treatment may be performed after the first electrode 40′ is formed.

And then, an electrolyte 50′ is formed on the first electrode (FIG. 9D). The electrolyte 50′ obtains crystallinity (is crystallized) through a high temperature deposition or through a thermal treatment after deposition.

And then, a second electrode 60′ is formed on the electrolyte 50 (FIG. 9E). If necessary, a follow-up thermal treatment may be performed.

After the first electrode, the electrolyte and the second electrode as shown in FIGS. 9C, 9D, and 9E are formed, thermal treatment for improving physical properties or crystallization may be performed sequentially after each step or may be simultaneously performed following two or three steps.

And then, an opening 13′ is formed from a lower surface of the substrate to a lower surface of the Al layer (FIG. 9F). To this end, the lower silicon nitride layer 11′ is patterned by using photoresist. Patterning is performed by including spin-on coating, lithography, photoresist developing, and selectively etching the lower silicon nitride layer 11′. Subsequently, an exposed Si portion is removed with KOH or the like by using the patterned lower silicon nitride layer 11′ as an etching mask. Dry etching can be used in removing the exposed Si portion.

And then, an anodizing process is performed to form an anodized aluminum oxide (AAO) layer 35′ having a porous layer 36′ and a barrier layer 37′ (FIG. 9G). In this case, power required for performing the anodizing process is applied to the first electrode 40′ to consume (namely, oxidize) the entire Al layer during the anodizing process, and then, the anodizing process is rather excessively performed to oxidize a portion of the first electrode 40′ being in contact with the barrier layer 37′ to form a removable metal oxide in a follow-up etching process.

Thereafter, the barrier layer and portions of the first electrode 40′ being in contact with the barrier layer are etched (FIG. 9H) to form pores 47′, namely, the passages allowing gas (fuel or air) to reach the first electrode 40′ and the electrolyte 50′ therethrough.

The final step of the fabrication process in the fourth embodiment of the present invention may be slightly modified to obtain the micro-fuel cell according to the fifth embodiment of the present invention. Namely, only the barrier layer 37′ is etched in the step as shown in FIG. 9H, and an electrode material, which is the same as or different from the first electrode, is deposited on the porous layer 36′ before the portions of the first electrode 40′ being in contact with the barrier layer is etched, and then, the portion of the first electrode and the additionally deposited electrode material are etched to form the micro-fuel cell according to the fifth embodiment (FIG. 9I).

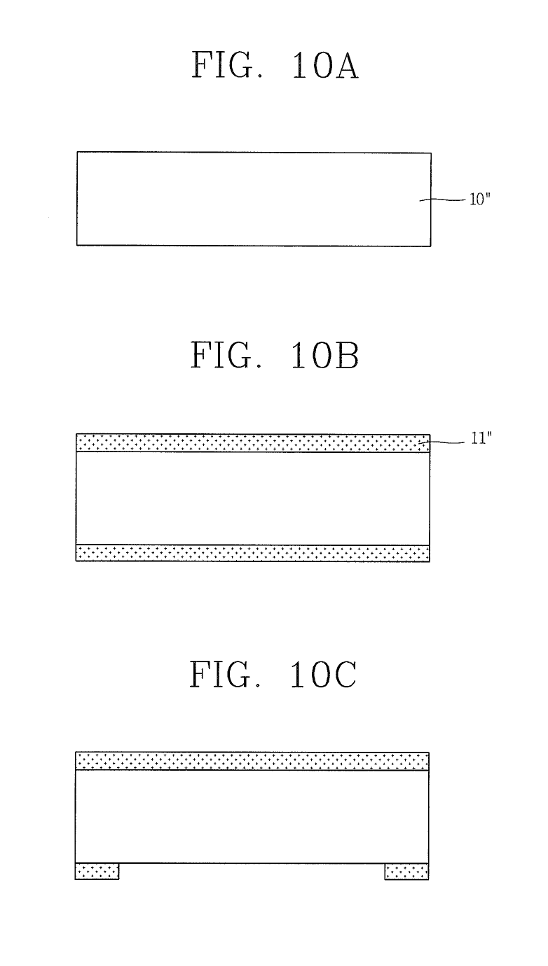

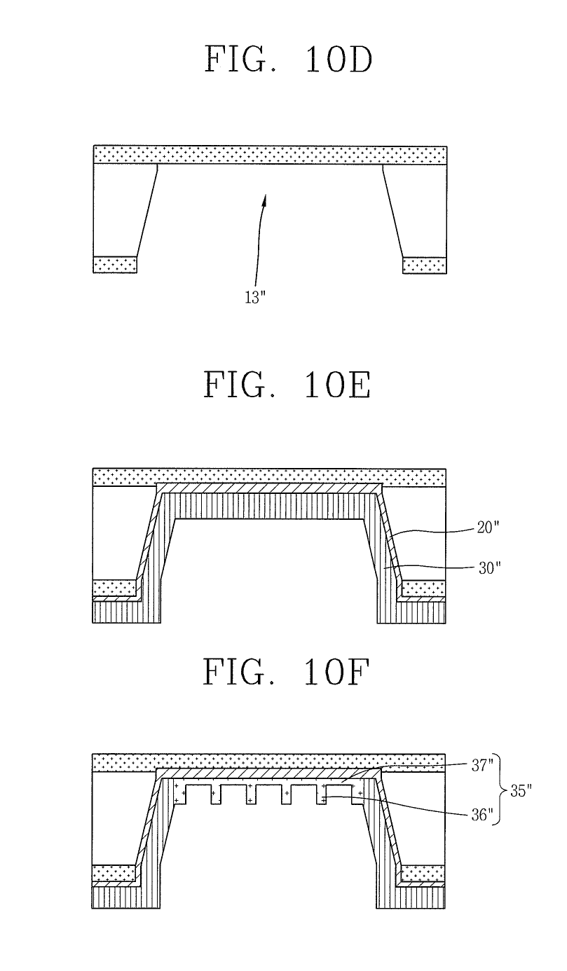

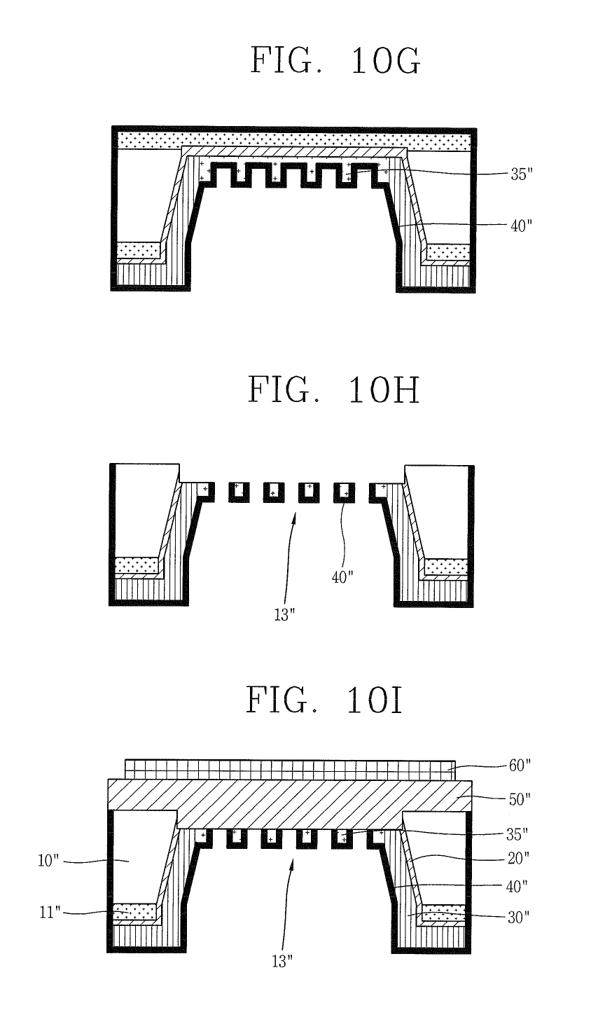

FIGS. 10A to 10I show a method for fabricating a micro-fuel cell according to still another embodiment of the present invention.

First, an opening 13″ is formed on a lower surface of a substrate 10″ (FIGS. 10A to 10D).

Next, a raw material of a template is deposited on a portion of the substrate 10″ with the opening 13″ formed thereon according to a thin film process to form a template thin film 30″ (FIG. 10E). In this case, if the substrate 10″ is not a conductor, an electrode to which power is to be applied may be formed in performing anodizing. Namely, before the formation of the template thin film 30″, the lower electrode 20″ may be formed.

And then, the template thin film 30″ are anodized to form an anodized aluminum oxide (AAO) layer 35″ having a porous layer 36″ and a barrier layer 37″ (FIG. 10F).

Thereafter, a first electrode 40″ is formed with a uniform thickness on the AAO layer 35″ using CVD method (FIG. 10G). In this case, PVD method can be used instead of CVD method.

And then, the upper surface of the substrate 10″, the barrier layer and portions of the first electrode formed on the barrier layer are etched to form a plurality of nano pores at the first electrode 40″ (FIG. 10H).

And, an electrolyte 50″ is formed on the porous layer 36″, on which a second electrode 60″ is then formed (FIG. 10).

FIGS. 11 to 14 show a micro-fuel cell stack and a packaging system formed by connecting in series the unit cells fabricated on the substrate by using connection lines.

As shown in FIGS. 11 to 14, a plurality of unit cells are horizontally disposed on the substrate, and the substrate supports the template. An opening is formed from a lower surface of the substrate to the nano pores formed at the porous electrode to secure a gas movement passage. Although not shown, instead of the opening, the substrate part below the porous electrode may have a porous structure to secure the gas movement passage.

FIG. 11 shows the structure in which one side includes all the same types of electrodes and connected in series by using connection lines 70. In this case, an air gap may be formed between the neighboring same (homogenous) electrodes or the neighboring same electrodes may be mutually insulated by using insulators 80.

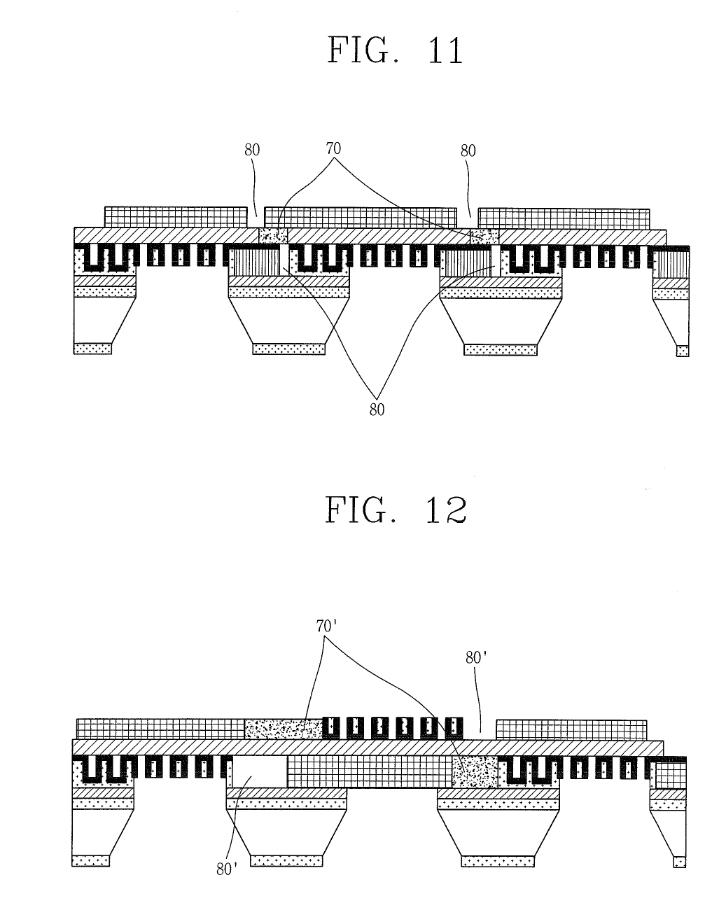

FIG. 12 shows the structure in which electrodes are alternately formed in a state that an electrolyte is entirely formed, and then connected in series by using connection lines 70′. In this case, an air gap may be formed between the neighboring electrodes each having the opposite polarity, not the serially connected poles, or the neighboring electrodes are mutually insulated by using insulators 80′.

Likewise, several unit cells may be connected in parallel by connecting homogenous electrodes of neighboring unit cells by connection lines and using a suitable insulation structure.

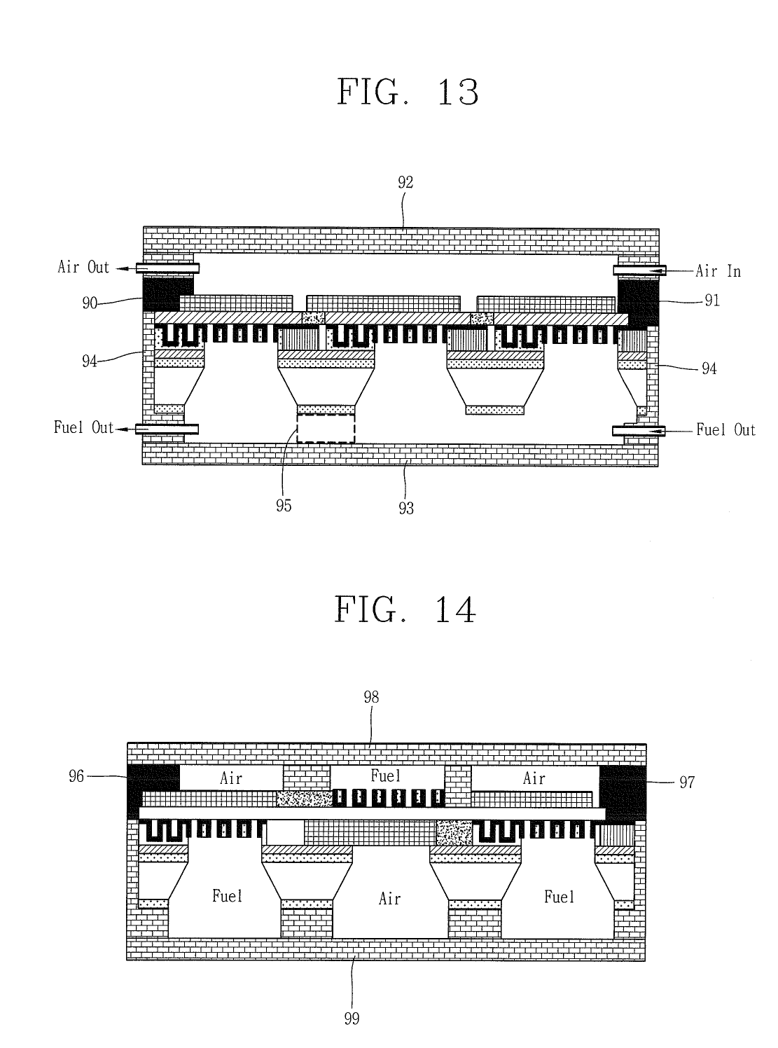

As for the structure as shown in FIG. 11, when a gas flow path is formed, the same type of gas can be supplied to one side, so the flow path can be simply formed to perform packaging as shown in FIG. 13.

A current collector 90 of the upper second electrode and a current collector 91 of the lower first electrode may be formed by depositing a conductive material, or may be configured as a portion of the packaging case as shown in FIG. 13. If a mechanical stability matters, a support structure may be formed by using a spacer at a position indicated by reference numeral 95. In the packinage case, a reference numeral 94 part (the side of the lower first electrode) should be sealed.

As for the structure as shown in FIG. 12, different gases should be alternately introduced, so flow paths may be formed as shown in FIG. 14. The neighboring electrodes each having the opposite polarity should be sealed. The flow paths may be formed by stamping a material that can be easily patterned or etched such as silicon or the like or a metal material, and it can be attached to a cell stack by using various bonding methods including wafer bonding, brazing, or the like.

The present invention has been described through the embodiments, but the embodiments are presented to allow the present invention to be more clearly understood but not to limit the scope of the present invention. The present invention will be defined within the scope of the technical idea of claims to be described.

### EMBODIMENT

Low stress silicon nitride was deposited with a thickness of 150 nm on Si wafer with a thickness of 300 μm according to LPCVD (FIG. 8A).

Next, one side of the silicon nitride-deposited wafer was patterned. In this case, positive photoresist (AZ 1512) was spin-coated and exposed to light by using a photomask having a square array of 520 μm×520 μm. The resulting structure was developed with a developer and silicon nitride was dry-etched (RIE) by using the remaining photoresist as a mask. The remaining photoresist was removed by using a photoresist remover.

Thereafter, Si was wet-etched for which a material of KOH:IPA:DIW=250 g:200 g:800 g was used as an etching solution and the etching was performed for five hours at 80° C. (FIG. 8C). The wafer is cut by the size of 2 cm×2 cm by using a dicing saw, and the cut substrate was washed by using an SPM (sulfuric acid+H2O2) solution or the like.

And then, TiN (20 nm) and Al (1 μm) layers were deposited on the silicon nitride (SixNy) layer by using a DC sputtering method. In this case, the TiN layer was performed under an atmosphere of Ar and N₂ at 5.3 mTorr in 150 W for 45 seconds by using reactive sputtering, and the Al layer was performed under the conditions of Ar 5 mTorr, 150 W for 16 minutes (FIG. 8D).

Thereafter, the Al layer was anodized. The anodizing conditions were 60V, 10° C., 0.3M oxalic acid (electrolyte). The first anodizing was performed for 200 seconds to consume about 600 nm of the Al layer. And then, the Al layer was put in a mixed solution of 6 wt % of phosphoric acid and 1.8 wt % of chromic acid at 50° C. for 30 minutes to remove the anodized AAO. Subsequently, the second anodizing was performed for 150 seconds to entirely consume the Al layer so as to be converted into alumina. The alumina was etched by using a mixed solution of 6 wt % of phosphoric acid and 1.8 wt % of chromic acid at 30° for 20 minutes to increase the size of pores from 30 nm˜40 nm to 70 nm˜80 nm (pore widening) (FIG. 8E).

And then, Ru (the first electrode) was deposited with a thickness of 15 nm˜20 nm by the ALD (Atomic Layer Deposition) method (FIG. 8F).

Subsequently, YSZ (electrolyte) was deposited with a thickness of about 200 nm˜1 μm according to an RF sputtering/PLD (Pulsed Laser Deposition) method (FIG. 8G).

And then, porous Pt (second electrode) was deposited with a thickness of about 100 nm through DC sputtering. The deposition conditions were Ar 75 mTorr, 25 W, and 200 seconds (FIG. 8H).

Thereafter, the rear surface of the substrate was dry/wet etched to secure a gas passage. In this case, silicon nitride and titanium nitride were dry-etched, titanium oxide was wet-etched (H2O2:NH4OH:DIW=1:1:5, 30 □, 3 minutes), the barrier layer of the AAO layer was wet-etched (mixed solution of 6 wt % of phosphoric acid and 1.8 wt % of chromic acid, 30° C. and 20 minutes), and the Ru was dry-etched.

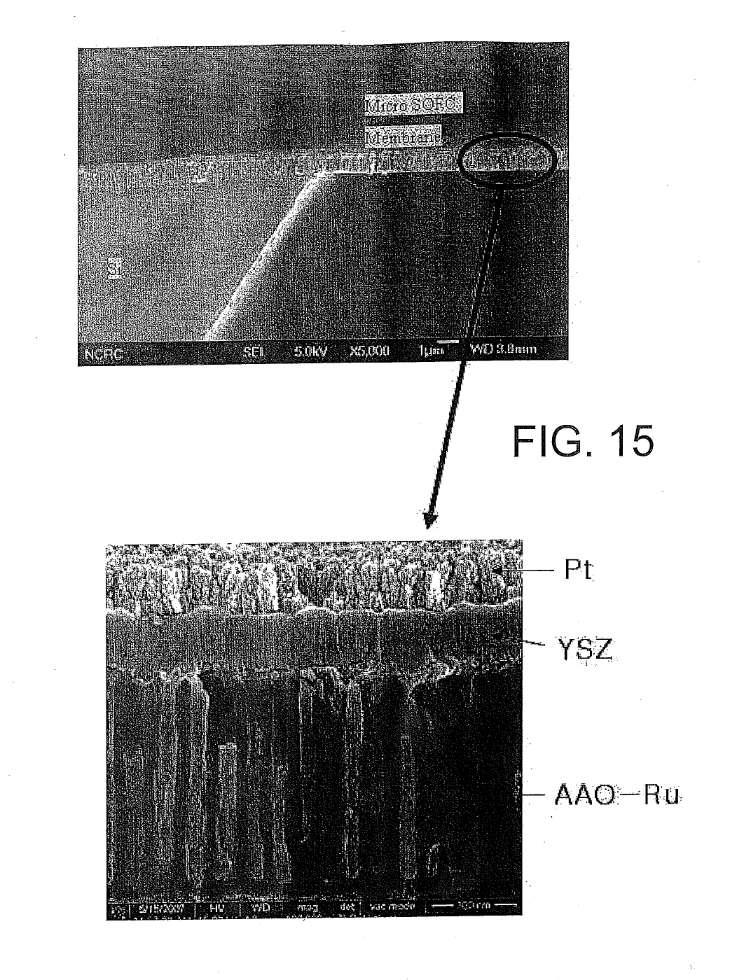

FIG. 15 shows the sectional structure of the micro SOFC implemented through the above-described process. The AAO was used as the template, the Ru was deposited as the anode through ALD, and YSZ was deposited as the electrolyte. In addition, the porous Pt deposited by increasing a process pressure was formed as the cathode. The silicon was etched through KOH, and the SOFC membrane was structurally stable up to 1 mm in size of the etched square opening. The YSZ electrolyte of about 200 nm was densely formed on the porous AAO structure, degradation of the structure was not found in a raising temperature testing up to 500° C., so it can meet the high temperature stability requirements of the micro-SOFC.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A micro-fuel cell, comprising:
a solid electrolyte and first and second electrodes separately formed on the electrolyte,
wherein at least one of the first and second electrodes is supported by a template having a plurality of nano pores formed by depositing, anodizing and etching a thin film, and is a porous electrode with nano pores formed at positions corresponding to the entirety or a portion of the plurality of nano pores formed on the template.

2. The micro-fuel cell of claim 1, wherein a corrugated surface of the template according to anodizing is directed upward, and the porous electrode is formed with a uniform thickness on an upper surface of the template and inner walls constituting the nano pores of the template.

3. The micro-fuel cell of claim 2, further comprising:
a lower electrode for anodizing at a lower portion of the template.

4. The micro-fuel cell of claim 1, wherein the corrugated surface of the template according to anodizing is directed downward, and the porous electrode is formed between the template and the electrolyte.

5. The micro-fuel cell of claim 1, wherein the corrugated surface of the template according to anodizing is directed downward, which is the opposite direction of the electrolyte surface, and the porous electrode is formed with a uniform thickness on a lower surface of the template and on the inner walls constituting the nano pores of the template.

6. The micro-fuel cell of claim 1, further comprising:
a substrate supporting the template and having an opening for securing a gas movement passage up to the nano pores formed at the porous electrode.

7. The micro-fuel cell of claim 1, further comprising:
a porous substrate supporting the temperate and having a partial or entire porous structure to secure a gas movement passage up to the nano pores formed at the porous electrode.

8. The micro-fuel cell of claim 1, wherein the electrolyte is positioned between the first and second electrodes.

9. The micro-fuel cell of claim 1, wherein the first and second electrodes are formed together on one surface of the electrolyte.

10. The micro-fuel cell of claim 1, wherein the template is made of at least one selected from the group consisting of aluminum (Al), titanium (Ti), magnesium (Mg), Zinc (Zn), tantalum (Ta), zirconium (Zr), Yttrium (Y), cerium (Ce), hafnium (Hf), niobium (Nb), and silicon (Si) or their alloys.

11. The micro-fuel cell of claim 1, wherein the porous electrode is highly dense or sparse.

12. A micro-fuel cell stack wherein a plurality of unit cells are disposed on a substrate, arbitrary two unit cells among the plurality of unit cells are connected in series or in parallel via a connection line, the unit cells include a solid electrolyte and the first and second electrodes separately formed on the electrolyte,
wherein at least one of the first and second electrodes is supported by a template having a plurality of nano pores formed by depositing, anodizing and etching a thin film, and is a porous electrode with nano pores formed at positions corresponding to the entirety or a portion of the plurality of nano pores formed on the template.

13. The stack of claim 12, wherein the plurality of unit cells are horizontally disposed on the substrate, the substrate supports the template, an opening is formed at the substrate to secure a gas movement passage from a lower surface of the substrate to the nano pores formed at the porous electrode.

14. A method for fabricating a micro-fuel cell, comprising:
depositing a raw material of a template on a substrate through a thin film process;
anodizing the deposited thin film to form an anodized thin film (anodized aluminum oxide layer) having a porous layer and a barrier layer;
forming a first electrode with a uniform thickness on the anodized thin film;
forming an electrolyte on the first electrode;
forming a second electrode on the electrolyte; and
etching the barrier layer and portions of the first electrode formed on the barrier layer to form a plurality of nano pores at the first electrode.

15. The method of claim 14, further comprising:
forming an opening from a lower surface of the substrate to the barrier layer before the barrier layer and the portions of the first electrode are etched.

16. The method of claim 14, wherein the substrate is porous and etching of the barrier layer and portions of the first electrode are made through pore passages secured in the substrate

17. A method for fabricating a micro-fuel cell, comprising:
depositing a raw material of a template on a substrate through a thin film process;
forming a first electrode on the deposited template thin film;
forming an electrolyte on the first electrode;
forming a second electrode on the electrolyte;
forming an opening from a lower surface of the substrate up to a lower surface of the template thin film on the substrate;
anodizing the template thin film to form an anodized thin film having a porous layer and a barrier layer; and
etching the barrier layer and portions of the first electrode being in contact with the barrier layer to form a plurality of nano pores at the first electrode.

18. The method of claim 17, further comprising:
depositing an electrode material which is the same as or different from the first electrode on the porous layer before the portions of the first electrode are etched.

19. A method for fabricating a micro-fuel cell, comprising:
forming an opening on a lower surface of a substrate;
depositing a raw material of a template on the portion of the substrate where the opening is formed through a thin film process;
anodizing the template thin film to form an anodized thin film having a porous layer and a barrier layer;
forming a first electrode with a uniform thickness on the anodized thin film;
etching an upper surface of the substrate, the barrier layer, and portions of the first electrode formed on the barrier layer to form a plurality of nano pores at the first electrode;
forming an electrolyte on the porous layer; and
forming a second electrode on the electrolyte.
